(19) United States
(12) Patent Application Publication
(10) Pub. No.: US 2017/0120438 A1
(43) Pub. Date: May 4, 2017

(54) Hand-Held Tool System, Method for Operating

(71) Applicant: Robert Bosch GmbH, STuttgart (DE)

(72) Inventor: Andreas Kynast, Stuttgart (DE)

(21) Appl. No.: 15/129,514

(22) PCT Filed: Mar. 26, 2015
(86) PCT No.: PCT/EP2015/056516

§ 371 Date: Sep. 27, 2016

(30) Foreign Application Priority Data
Apr. 2, 2014 (DE) 10 2014 206 289.6

(51) Int. Cl. B25H 1/00; B25F 5/02

(52) U.S. Cl. CPC B25H 1/0085; B25F 5/021

(57) ABSTRACT

A hand-held tool system includes a hand-held power tool, in particular a drill, having a wall device configured to be mounted on a wall to be processed by the hand-held power tool. The wall device includes at least a first sensor device that is configured to determine an orientation of the hand-held power tool relative to the wall device.

The invention relates to a hand-held tool system, having a hand-held power tool, in particular a power drill.

### PRIOR ART

Hand-held tool systems of the type mentioned at the outset are known from the prior art. In performing work on workpieces, for an advantageous work result it is necessary for the alignment of the hand-held power tool to be set optimally in relation to the workpiece on which work is to be performed. In the case of power drills, for example, it is important that the power drill be aligned at a particular angle in relation to the surface on which work is to be performed, in particular at right angles to the surface of the workpiece on which work is to be performed. In the case of non-mobile applications such as, for example, in the case of bench routers or bench drills, this alignment is easily achieved through the arrangement of the power tool in relation to a workpiece holder. In this case, a correct alignment is understood to mean, in particular, the alignment of the tool of the (hand-held) power tool in relation to a workpiece, in particular a wall. In the case of mobile tool appliances, in particular in the case of hand-held power tools, the alignment must be manually set and held by the user themselves. Incorrect settings can then easily occur, especially in the case of drilling on/in a vertical wall, and consequently produce unwanted work results.

### DISCLOSURE OF THE INVENTION

The hand-held tool system according to the invention, having the features of claim 1, has the advantage that the alignment of the hand-held power tool is monitored automatically for the user, such that an optimum work result can always be achieved, at least insofar as the user also takes account of the sensed alignment. Provided for this purpose, according to the invention, is a wall device, which can be mounted on the workpiece, or a wall, on which work is to be performed, and which has at least one first sensor device that is realized to determine an alignment of the hand-held power tool in relation to the wall device. The invention thus provides an additional device that can be mounted on the wall on which work is to be performed. This wall device, referred to in the following as a device, has a sensor device that determines the alignment of the hand-held power tool in relation to the wall device. The alignment of the hand-held power tool in relation to the wall device is thus determined continually by the hand-held tool system according to the invention. The alignment of the hand-held power tool in relation to the wall on which work is to be performed can thus be easily deduced with an appropriate design of the wall device. In the simplest case, the hand-held power tool is thus supplemented only by the wall device, such that even a conventional hand-held power tool can be used. Preferably, the wall device has an indicator device, by which the alignment of the hand-held power tool in relation to the wall device is visually or acoustically indicated to the user. It may be provided in this case that the indicator device visually or acoustically indicates to the user when the hand-held power tool is in a desired alignment, in particular is perpendicular to the wall. For this purpose, the indicator device may have, for example, one or more light sources that, for example by displaying differing colors, indicate a correct or incorrect alignment of the hand-held power tool, in dependence on the determined alignment.

According to an advantageous development of the invention, it is provided that the first sensor device has a first acceleration sensor. The acceleration sensor enables the alignment of the wall device itself, or its position in space, to be determined in a simple manner. Preferably, a plurality of acceleration sensors are provided, which act in differing directions, or it is preferred to provide a 3-axis acceleration sensor, which senses the accelerations in three differing spatial directions. By sensing the position of the wall device itself, it is possible to determine, for example, whether the wall or surface on which work is to be performed is aligned vertically or obliquely. Then, preferably, depending on the determined position, the correct alignment of the hand-held power tool is determined and, for example, indicated accordingly to the user. It is provided, particularly preferably, that there is an input unit, by means of which the user can specify a desired alignment of the hand-held power tool, or of the tool of the hand-held power tool, in relation to the surface or wall. This is important, for example, if drilling is to be effected, not perpendicularly in relation to the surface of the wall, but, for example, obliquely thereto.

According to an advantageous development of the invention, it is provided that the hand-held power tool has a second sensor device, having a second acceleration sensor, wherein means are provided that are realized to compare measured values of the first sensor device with measured values of the second sensor device. Owing to the provision of a second acceleration sensor on the hand-held power tool, it is likewise possible to determine the position of the hand-held power tool in space. Preferably, the design of the second acceleration sensor corresponds to the design of the first acceleration sensor, such that the first sensor device and the second sensor device each provide comparable measured values. The second acceleration sensor in this case is expediently aligned or disposed on the hand-held power tool in such a manner that the assignment of the position of the acceleration sensor in relation to the hand-held power tool, or in relation to a tool of the hand-held power tool, is unambiguous. In particular, the acceleration sensors are calibrated in such a manner that, when the wall device is aligned on a vertical wall and the hand-held power tool is aligned perpendicularly in relation to the wall, the measured values from the first acceleration sensor and from the second acceleration sensor, or from the first sensor device and the second sensor device, correspond. The alignment of the hand-held power tool in relation to the wall device, and therefore of the tool in relation to the wall, can then be deduced in a rapid and simple manner by comparing the measured values of the first sensor device with the measured values of the second sensor device.

Furthermore, it is preferably provided that the first sensor device has a first compass device, and the second sensor device has a second compass device. An absolute position of the wall, or wall device, and of the hand-held power tool can be determined, or at least estimated, by the compass device. Owing to the additional provision of the compass device, it can be ensured that the hand-held power tool is correctly aligned relative to the wall, even if the measured values of the acceleration sensors correspond to each other. In particular, it can thereby be ensured that the hand-held power tool, with the tool, is facing toward the wall, and not, for example, in the opposite direction.

According to an advantageous development of the invention, it is provided that the means have a communication device for wireless data transmission. By means of the communication device, the wall device and the hand-held power tool, or the first sensor device and the second sensor device, exchange the sensed measured values, to enable them to be compared with each other. In particular, it is provided that the second sensor device transmits its measured values to the first sensor device, such that the determination of the alignment of the hand-held power tool in relation to the wall is performed by the wall device. Accordingly, the wall device may be provided with the previously mentioned indicator device. Alternatively, it is also conceivable for the measured values of the first sensor device and the measured values of the second sensor device to be determined by a control unit of the hand-held power tool, such that the determination of the alignments is effected by the hand-held power tool. Accordingly, in this case, the indicator device is expediently assigned to the hand-held power tool. Alternatively, it is also conceivable for the sensor devices to exchange the data with each other in both directions and compare the data in each case, in order to determine the alignment of the hand-held power tool.

Furthermore, it is preferably provided that there is an enabling device, which compares the measured values with each other and enables use of the hand-held power tool only if the measured values correspond or almost correspond. The enabling device indicates to the user, in particular, whether use has or has not been enabled. Accordingly, the enabling device preferably has the previously mentioned indicator device, which, by indicating corresponding information, enables the user to use the hand-held power tool, or prohibits their use thereof. Particularly preferably, the enabling device is realized such that it is connected to a drive device of the hand-held power tool, in order to prevent the operation of the hand-held power tool if the alignment does not correspond to the desired or specified alignment. In the case of an incorrect alignment, it is consequently not possible for the user to perform a work operation. It is only when the alignment is correct that the enabling device effects enabling and enables the operation of the drive device, such that the work operation can be performed.

According to an advantageous development of the invention, it is provided that the first sensor device has at least one camera sensor, which is realized to sense predefinable orientation points of the hand-held power tool, in order to determine the alignment of the hand-held power tool with respect to the wall device in dependence on the orientation points. According to this embodiment, it is thus provided that the sensor device has a camera sensor that optically ascertains the alignment of the hand-held power tool in relation to the wall device, and thus in relation to the wall. Orientation features of the hand-held power tool are preferably defined for the first sensor device, or the camera sensor. This may be effected, for example, on the basis of references images or the like. The orientation features may be, for example, an inscription on the hand-held power tool, the appearance of which differs accordingly for the camera sensor, depending on the alignment of the hand-held power tool in relation to the wall device. The work operation is enabled and/or the correct alignment is indicated to the user only when the sensed inscription corresponds in its shape, or alignment, to the inscription that, in particular, has been previously stored. Preferably, a plurality of camera sensors are provided, to enable three-dimensional sensing of the alignment of the hand-held power tool in relation to the wall device. The camera sensor or camera sensors is or are provided, in particular, as an alternative to the acceleration sensor of the wall device. Alternatively, however, it is also conceivable to provide both an acceleration sensor and at least one camera sensor on the wall device, in order to optimize the alignment determination result.

Furthermore, it is preferably provided that the first sensor device has at least one spirit level and/or at least one acceleration sensor, in order to optimize the alignment of the wall device on the wall. The acceleration sensor may be, in particular, the previously mentioned first acceleration sensor. The spirit level, which may also be realized as a digital spirit level, makes it easy for the user, expediently, to align and fasten the wall device on the wall, such that the subsequent sensing of the alignment of the hand-held power tool produces the desired work result.

Furthermore, it is preferably provided that the first sensor device and/or the second sensor device have/has an antenna device having a directional characteristic. In particular, the antenna devices is or are provided as an alternative to the previously described compass devices. The alignment of the power tool in relation to the wall device can be determined unambiguously on the basis of the propagation times of emitted and received signals of the antenna devices of the hand-held power tool and of the wall device. In each case, the first sensor device and/or the second sensor device have/has a respective control unit that compares the sensed measured data with each other, in order to determine the alignment.

Preferably, the wall device is realized as a mobile computer, which has means for fastening to a wall. The means may be, for example, pointed projections that can be inserted into the wall in the manner of a nail for the purpose of fastening. The fastening means may also be one or more adhesive strips. It is likewise conceivable for the mobile computer, a housing of the mobile computer or a holding shell for the mobile computer, or the mobile telephone, to have fastening tabs, through which, for example, nails can be driven for the purpose of fastening the wall device to the wall. In particular, it is provided that the mobile computer is realized as a so-called smartphone, or mobile telephone. Modern mobile telephones already have acceleration sensors for sensing their position, as well as compass devices. The implementation of a corresponding software enables the data sensed by the mobile computer, or mobile telephone, to be compared with the data of the second sensor device on the hand-held power tool, and thus enables the alignment of the hand-held power tool with respect to the wall device to be determined in a simple manner.

The method according to the invention, having the features of claim 10, results in the advantages already stated above. It is provided in this case that an alignment of the hand-held power tool in relation to the wall device is ascertained by means of the first sensor device, and the hand-held tool system is operated in dependence on the sensed alignment. In particular, it is provided in this case that a work operation is enabled or prevented in dependence on the sensed alignment. Alternatively or additionally, it is provided that it is optically or visually indicated to the user, in dependence on an alignment, whether or not the alignment corresponds to a predefined or desired alignment. Further preferred features and advantages of the method are given in the description above, and in the dependent claims.

The invention is to be explained in greater detail in the following on the basis of exemplary embodiments.

For this purpose:

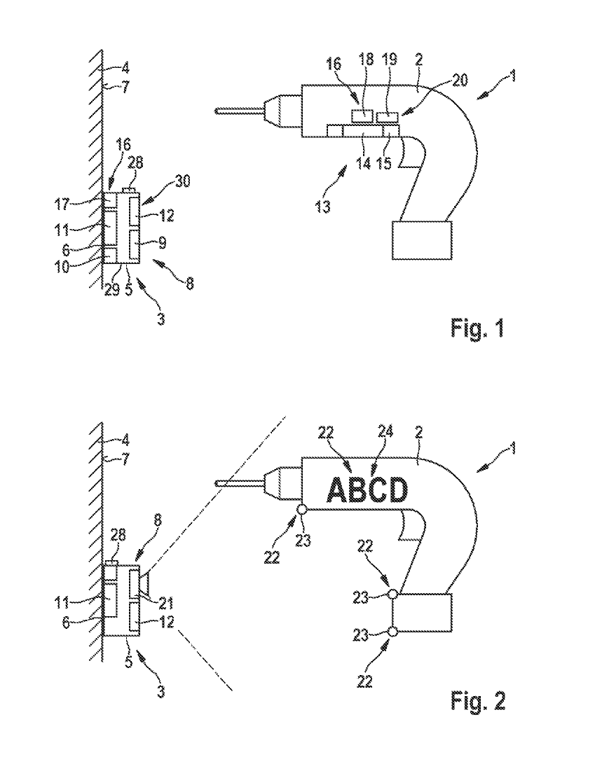

FIG. 1 shows a first exemplary embodiment of an advantageous hand-held power tool system,

FIG. 2 shows a second exemplary embodiment of the advantageous hand-held power tool system, and

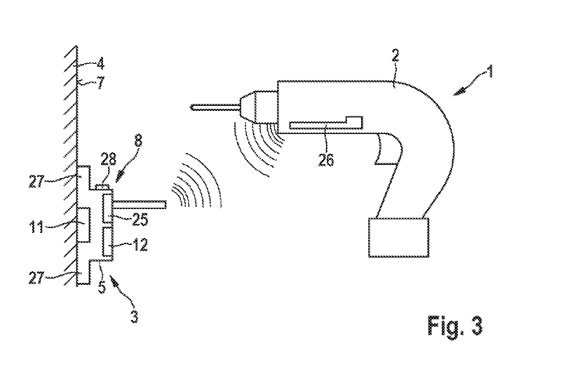

FIG. 3 shows a third exemplary embodiment of the hand-held tool system, in a simplified representation in each case.

FIG. 1 shows a hand-held tool system 1, in a simplified representation. The hand-held tool system 1 has a hand-held power tool 2, which in the present case is realized as a power drill. The hand-held tool system 1 additionally has a wall device 3. The wall device 3 is disposed on a wall 4, on which work is to be performed by means of the hand-held power tool 2. For this purpose, the wall device 3 has a housing 5, which in the present case is fastened to an outer surface 7 of the wall 4 by an adhesive strip 6.

The wall device 3 has a first sensor device 8. The latter has an acceleration sensor 9 and an optional compass device 10. The acceleration sensor 9 is realized as a 3-axis acceleration sensor, which determines the position of the wall device 3 in space. Furthermore, the wall device 3 has a control unit 11, for evaluating the measured values sensed by the sensor device 8, and an indicator device 12. The indicator device 12 has, for example, a controllable display or one or more light sources, in particular light-emitting diodes.

The hand-held tool system 1 additionally has a second sensor device 13, which is assigned to the hand-held power tool 2. The sensor device 13 has a second acceleration sensor 14, which is likewise realized as a 3-axis acceleration sensor, for sensing the position of the hand-held tool 2 in space. Optionally, the second sensor device 13 has a second compass device 15.

The hand-held tool system 1 additionally has means 16 that enable data to be exchanged between the wall device 3 and the hand-held power tool 2. In particular, the means 16 are realized as a wireless communication interface, for which purpose the hand-held power tool 2 and the wall device 3 each have, in particular, a corresponding communication device 17, 18, for example in the manner of a Bluetooth module. A control unit 19 assigned to the hand-held power tool 2 evaluates, for example, the measured values sensed by the sensor device 13, and sends these to the communication device 17 of the wall device 3 by means of the communication device 18 assigned to the hand-held power tool 2. The control unit 11 compares measured values sensed by the sensor device 13 with those sensed by the sensor device 8, in order to determine the alignment of the hand-held power tool 2 with respect to the wall device 3. An appropriate disposition and/or calibration of the sensor device 8 of the wall device 3 enables the alignment of the hand-held power tool 2 with respect to the wall 4, and in particular with respect to the outer surface 7 of the wall 4 on which work is to be performed, to be determined therefrom. In particular, a correct alignment is identified if the measured values of the sensor device 8 and 13 correspond.

If the sensed measured values correspond, the correct alignment is indicated to the user by means of the indicator device 12, for example by the activation of a colored light source. Alternatively or additionally, it may be provided that, if the measured values correspond, the control unit 19 of the hand-held power tool 2 enables the operation of the hand-held power tool 2, and, if the measured values do not correspond, prevents the operation of the hand-held power tool 2. The control unit 19 thus constitutes an enabling device 20, which allows the hand-held power tool 2 to be operated only if the alignment with respect to the wall 4 corresponds to a desired alignment. A desired alignment in this case is to be understood to mean, in particular, a perpendicular alignment of the drill tip of the hand-held power tool 2 in relation to the wall 4, or to the surface 7.

The accuracy of the sensed alignment is further increased by taking account of the measured values of the compass devices 10 and 15. In particular, it is ensured by means of the compass devices 10 and 15 that the hand-held power tool 2 is aligned with the tool tip toward the wall 4.

FIG. 2 shows a second exemplary embodiment of the hand-held tool system 1, wherein elements already known from FIG. 2 are denoted by the same references and, to that extent, reference is made to the description given above. In the following, it is substantially only the differences that are described.

According to the exemplary embodiment of FIG. 2, it is provided that, unlike the preceding exemplary embodiment, the wall device 3 has, as a sensor of the sensor device 8, a camera sensor 21, which is realized to sense and recognize the hand-held power tool 2, and in particular orientation features 22 of the hand-held power tool 2, in order to determine the alignment of the hand-held power tool 2 in relation to the wall device 3 on the basis of the alignment of orientation features 22 in relation to each other, or the appearance of the orientation feature or features themselves. For this purpose, the hand-held power tool 2 in this case is provided with three colored, prominent orientation points 23, which are disposed at a distance apart from each other. The camera sensor 21 senses the three marking points 23, and compares their alignment and arrangement to a reference arrangement stored in a memory of the sensor device 8, in order to determine whether the hand-held power tool 2 is in a desired, or the specified, alignment.

Instead of the marking points 23, an inscription 24 may also be used as an orientation feature 22. The inscription 24, represented exemplarily here as capital letters “ABCD”, appears with differing distortion, depending on the alignment of the hand-held power tool 2 in relation to the wall device 3. By storing a reference image, or reference alignment, of the letters, the control unit 11 can compare the image sensed by the camera sensor 21 with the stored image, and thus deduce a correct alignment of the hand-held power tool 2, in particular taking account of a scaling that represents the distance of the hand-held power tool 2 from the wall device 3.

Clearly, it is also conceivable for the camera device 21 to be realized to sense all recognition features, or orientation features 22, of the hand-held power tool 2 that are shown here, and to evaluate them accordingly.

FIG. 3 shows a further exemplary embodiment of the hand-held tool system 1, which differs from the preceding exemplary embodiments in that the first sensor device 8 has an antenna device 25 having a directional characteristic. The antenna device 25 emits signals, and receives either reflections of these signals, or signals of a corresponding antenna device 26 having a directional characteristic that is provided on the hand-held power tool 2. The control unit 11 identifies the alignment of the hand-held power tool 2 in relation to the wall 4 on the basis of the propagation times of emitted and received signals.

Whereas, in the preceding exemplary embodiments, the housing 5 of the wall device 3 is additionally fastened to the wall 4 by the adhesive strip 6, in the present exemplary embodiment it is provided that the wall device has fastening tabs 27, through which, for example, short nails can be driven to fasten the wall device 3 to the wall 4.

In order to ensure an advantageous alignment of the wall device 3 on the wall 4, the wall device 3 may also be provided with an optional spirit level 28, such that the correct alignment of the wall device 3 on the wall 4 can be achieved, in order to ensure correct determination of the alignment of the hand-held power tool 2.

The housing 5, particularly in the case of the exemplary embodiment of FIG. 1, may also be a holding shell 29, in which there can be inserted a mobile computer, in particular a mobile telephone 30, having a corresponding acceleration sensor 9 and a communication device 17, and a control unit 11. The mobile telephone 30 can then be used as a wall device 3, as described previously, or constitute the latter, for determining the alignment of the hand-held power tool 2. It is also conceivable to use the mobile telephone 30 in the exemplary embodiment of FIG. 2, in which case the mobile telephone 30 then also provides the camera sensor 21, on the side having the display, to enable optical determination of the alignment of the hand-held power tool 2.

1. A hand-held tool system, comprising:
a hand-held power tool comprising a wall device configured to be mounted on a wall on which work is to be performed with the hand-held power tool, the wall device including at least one first sensor device that is configured to determine an alignment of the hand-held power tool in relation to the wall device.

2. The hand-held tool system as claimed in claim 1, wherein the first sensor device has a first acceleration sensor.

3. The hand-held tool system as claimed in claim 2, wherein the hand-held power tool further comprises (i) a second sensor device having a second acceleration sensor, and (ii) a comparing device configured to compare measured values of the first sensor device with measured values of the second sensor device.

4. The hand-held tool system as claimed in claim 3, wherein the first sensor device has a first compass device, and the second sensor device has a second compass device.

5. The hand-held tool system as claimed in claim 1, wherein the hand-held power tool includes at least one communication device configured for wireless data transmission.

6. The hand-held tool system as claimed in claim 3, further comprising:
an enabling device, configured to compare the measured values of the first sensor device and the measured values of the second sensor device and to enable use of the hand-held power tool only if the compared measured values correspond. The hand-held tool system as claimed in claim 1, wherein the first sensor device has at least one camera sensor configured to sense predefinable orientation points of the hand-held power tool in order to determine the alignment of the hand-held power tool with respect to the wall device in dependence on the predefinable orientation points.

8. The hand-held tool system as claimed in claim 3, wherein at least one of the first sensor device and the second sensor device has an antenna device having a directional characteristic.

9. The hand-held tool system as claimed in claim 1, wherein the wall device is configured as a mobile computer including a fastening member for fastening the wall device to the wall.

10. A method for operating a hand-held tool system having a hand-held power tool and a wall device, comprising:
fastening the wall device to a wall, the wall device having at least one first sensor device;
sensing an alignment of the hand-held power tool in relation to the wall device with the first sensor device; and
operating the hand-held tool system in dependence on the sensed alignment.
